(19) United States
(12) Patent Application Publication
(10) Pub. No.: US 2026/0319320 A1
(43) Pub. Date: Oct. 15, 2026

(54) LARGE-AREA ELECTROPHORETIC DISPLAY HAVING TILED FRONT PLANE LAMINATE PANELS

(71) Applicant: E Ink Corporation, Billerica, MA (US)

(72) Inventors: Weidong LI, Pleasanton, CA (US); Trung Quoc NGUYEN, Pleasanton, CA (US); Tony DAI, Fremont, CA (US); Yajuan CHEN, Fremont, CA (US); Yih-Ming KANG, Fremont, CA (US); HongMei ZANG, Fremont, CA (US)

(21) Appl. No.: 19/645,474

(22) Filed: Apr. 13, 2026

Related U.S. Application Data
(60) Provisional application No. 63/788,305, filed on Apr. 14, 2025.

(51) Int. Cl. G02F 1/1681; G02F 1/167

(52) U.S. Cl. CPC G02F 1/1681; G02F 1/167

(57) ABSTRACT

A microcell panel assembly in an electrophoretic display has a plurality of microcell panels, each including (a) a base layer having peripheral edges; (b) at least one sidewall extending orthogonally from one side of the base layer along one or more peripheral edges of the base layer; and (c) partition walls extending orthogonally from the one side of the base layer to define with the sidewall and the base layer an array of microcells sealable by a sealing layer for holding electrophoretic fluid therein. The microcell panels are joined to each other in a side-by-side tiled arrangement such that a sidewall of each microcell panel is aligned with and adjacent to a sidewall of an adjacent microcell panel at a seam between the adjacent microcell panels. The thickness of each sidewall is greater than the thickness of the partition walls to reduce risk of electrophoretic fluid leakage at the seam.

### CROSS REFERENCE TO RELATED APPLICATION(S)

This application claims priority from U.S. Provisional Patent Application No. 63/788,305 filed on Apr. 14, 2025, entitled LARGE-AREA ELECTROPHORETIC DISPLAY HAVING TILED FRONT PLANE LAMINATE PANELS, which is hereby incorporated by reference in its entirety.

### TECHNICAL FIELD

The subject matter disclosed herein generally relates to electrophoretic displays and, in particular, to large-area electrophoretic displays constructed from an array of front plane laminate panels in a tiled arrangement.

### BACKGROUND

An electrophoretic display (EPD) is a non-emissive display device based on the electrophoresis of charged pigment particles dispersed in a solvent or solvent mixture. The display typically comprises two electrodes placed opposing each other that provide an electric field to drive the motion of the charged pigment particles. One of the electrodes is usually transparent. When a voltage difference is imposed between the two electrodes, the pigment particles migrate to one side or the other causing either the color of the pigment particles or the color of the solvent (if colored) being seen from the viewing side.

Many EPDs incorporate an electrophoretic fluid that includes a non-polar solvent and one or more sets of charged pigment particles. The particles can have different optical properties (colors), different charges (positive or negative), different charge magnitudes (zeta potentials), and/or different absorptive properties (broadly light-absorbing or broadly light-reflecting, or selectively-absorbing or selectively reflecting). In instances where there are multiple particle sets with opposite charge polarities, application of an electric field between the electrodes can selectively cause a pigment particle of one set to appear at the viewing surface while the other pigment particle is driven away from the viewing surface.

Many EPDs are bi-stable meaning the optical state of such displays persists even after the activating electric field is removed. Bistability is primarily a result of induced dipole charge layers forming around the charged pigments due to complex interactions between the pigments, charge control agents, and free polymers dispersed in the solvent. A bistable display can last for years in the last-addressed optical state until being switched again with the application of a new driving field.

Driving an EPD requires a power source such as a battery to provide power to the display and/or its driving circuitry. For example, a battery may be used to supply power to a driver integrated circuit (IC) that in turn generates an electric field to energize the display's electrodes. The power source could also be, e.g., a photovoltaic cell, a fuel cell, a piezo-electric element, or a power supply that receives power from a wall outlet.

Driving circuitry is typically utilized to provide an electrical pathway between the power source and the electrodes. The circuitry typically includes control elements (e.g., switches, transistors, etc.), and a number of discrete components (e.g., resistors, capacitors, etc.).

### SUMMARY

One aspect of the invention relates to a microcell panel assembly comprising a plurality of microcell panels in an electrophoretic display. Each microcell panel comprises (a) a base layer having a plurality of peripheral edges; (b) at least one sidewall extending orthogonally from one side of the base layer along one or more of the peripheral edges of the base layer; and (c) a plurality of partition walls extending orthogonally from the one side of the base layer to define with the at least one sidewall and the base layer an array of microcells sealable by a sealing layer for holding electrophoretic fluid therein. The microcell panels are joined to each other in a side-by-side tiled arrangement such that at least one sidewall of each microcell panel is aligned with and adjacent to a sidewall of an adjacent microcell panel at a seam between the adjacent microcell panels. The thickness of each sidewall is greater than the thickness of the partition walls to reduce risk of leakage of the electrophoretic fluid at the seam.

Another aspect of the invention relates to an electrophoretic display. The display comprises a plurality of microcell panels joined to each other in a side-by-side tiled arrangement. Each microcell panel comprises: (a) a base layer having a plurality of peripheral edges, (b) at least one sidewall extending orthogonally from one side of the base layer along one or more of the peripheral edges of the base layer, and (c) a plurality of partition walls extending orthogonally from the one side of the base layer to define with the at least one sidewall and the base layer an array of microcells for holding electrophoretic fluid. The microcell panels are joined to each other such that a sidewall of each microcell panel is aligned with and adjacent to a sidewall of an adjacent microcell panel at a seam between the adjacent microcell panels. The thickness of each sidewall is greater than the thickness of the partition walls to reduce risk of leakage of the electrophoretic fluid at each seam. A light transmissive electrode layer is superposed on a viewing side of each of the plurality of microcell panels. A backplane comprising at least one electrode is superposed on a side of the plurality of microcell panels opposite to the viewing side.

Another aspect of the invention relates to a method of manufacturing an electrophoretic display. The method comprises the steps of: (a) forming a plurality of microcell panels each on a light transmissive electrode layer, each microcell panel comprising a base layer having a plurality of peripheral edges; at least one sidewall extending orthogonally from one side of the base layer along one or more of the peripheral edges of the base layer; and a plurality of partition walls extending orthogonally from the one side of the base layer to define with the at least one sidewall and the base layer an array of microcells for holding electrophoretic fluid, wherein the thickness of each sidewall is greater than the thickness of the partition walls; (b) filling the microcells of each microcell panel with the electrophoretic fluid and sealing the electrophoretic fluid in the microcells with a sealing layer; (c) joining the microcell panels to each other in a side-by-side tiled arrangement such that a sidewall of each microcell panel is aligned with and adjacent to a sidewall of an adjacent microcell panel at a seam between the adjacent microcell panels; and (d) securing a backplane comprising at least one electrode on a side of the microcell panels joined in step (c) opposite the light transmissive electrode layers.

In one or more embodiments, the thickness of the partition walls is about 2 um to 50 um, preferably about 12 um. In one or more embodiments, the thickness of each sidewall is about 4 um to 5000 um, preferably about 50 um.

In one or more embodiments, each microcell has a round, square, rectangular, or hexagonal shape.

In one or more embodiments, the seams between the adjacent microcell panels are not edge sealed.

In one or more embodiments, each seam between the adjacent microcell panels is sealed with a filler material. In one or more embodiments, the filler material comprises an epoxy.

In one or more embodiments, the tiling gaps at each seam between adjacent microcell panels are tapered such that the end of each tiling gap at the viewer-facing side of the electrophoretic display is narrower than the opposite end.

In one or more embodiments, the base layer, the at least one sidewall, and the plurality of partition walls in each microcell panel are integrally constructed.

In one or more embodiments, the plurality of microcell panels are formed by an embossing process.

In one or more embodiments, the at least one sidewall is formed on the base layer using inkjet printing, screen printing, or gravure printing.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic cross-sectional view of a representative EPD in which the electrophoretic medium is encapsulated in microcells in accordance with the prior art.

FIG. 2 is a simplified diagram illustrating an exemplary process for producing an EPD in accordance with the prior art.

FIG. 3A is a photograph illustrating a large-area EPD constructed from an array of front plane laminate panels in a tiled arrangement in accordance with one or more embodiments.

FIG. 3B is an exploded view of the EPD of FIG. 3A.

FIG. 4 is a cross-section view of a portion of an EPD in accordance with one or more embodiments.

FIG. 5 is a top plan view of a portion of an EPD in accordance with one or more embodiments.

FIG. 6 shows the edge damage gap between adjacent microcell panels in a prior art tiled display (left side image) and microcell panels with sidewalls in accordance with various embodiments (right side image).

FIG. 7 shows the results of reliability testing for edge damage growth over time for a prior art tiled display (left side image) and microcell panels with sidewalls in accordance with various embodiments (right side image).

FIG. 8 shows the results of reliability testing for edge damage growth over time for a tiled display without filler material in the edge gap (left side image) and a tiled display with filler material in the edge gap (right side image).

FIGS. 9A-9C show patterned sidewalls in accordance with one or more alternative embodiments.

### DETAILED DESCRIPTION

Several types of electro-optic displays are known. One type of electro-optic display uses an electrochromic medium, e.g., an electrochromic medium in the form of a nanochromic film comprising an electrode formed at least in part from a semi-conducting metal oxide and a plurality of dye molecules capable of reversible color change attached to the electrode; see, e.g., O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, e.g., in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display that has been the subject of intense research and development for a number of years is the particle-based EPD, in which a plurality of charged particles move through a fluid under the influence of an electric field. EPDs can have attributes of good brightness and contrast, wide viewing angles, state bistability, and low power consumption when compared with liquid crystal displays.

An EPD typically comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of EPD, which is intended for use with a stylus, print head, or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see, e.g., U.S. Pat. Nos. 7,002,728 and 7,679,814;
(b) Capsules, binders and encapsulation processes; see, e.g., U.S. Pat. Nos. 6,922,276 and 7,411,719;
(c) Films and sub-assemblies containing electro-optic materials; see, e.g., U.S. Pat. Nos. 6,982,178 and 7,839,564;
(d) Backplanes, adhesive layers and other auxiliary layers and methods used in displays; see, e.g., U.S. Pat. Nos. 7,116,318 and 7,535,624;
(e) Color formation and color adjustment; see, e.g., U.S. Pat. Nos. 7,075,502 and 7,839,564;
(f) Methods for driving displays; see, e.g., U.S. Pat. Nos. 7,012,600 and 7,453,445;
(g) Applications of displays; see, e.g., U.S. Pat. Nos. 7,312,784 and 8,009,348;
(h) Non-electrophoretic displays, as described in U.S. Pat. Nos. 6,241,921; 6,950,220; 7,420,549 and 8,319,759; and U.S. Patent Application Publication No. 2012/0293858;
(i) Microcell structures, wall materials, and methods of forming microcells; see, e.g., U.S. Pat. Nos. 7,072,095 and 9,279,906; and
(j) Methods for filling and sealing microcells; see, e.g., U.S. Pat. Nos. 7,144,942 and 7,715,088.

Many of the aforementioned patents and applications recognize that the walls surrounding the discrete microcapsules in an encapsulated electrophoretic medium could be replaced by a continuous phase, thus producing a so-called polymer-dispersed EPD, in which the electrophoretic medium comprises a plurality of discrete droplets of an electrophoretic fluid and a continuous phase of a polymeric material, and that the discrete droplets of electrophoretic fluid within such a polymer-dispersed EPD may be regarded as capsules or microcapsules even though no discrete capsule membrane is associated with each individual droplet; see, e.g., the aforementioned U.S. Pat. No. 6,866,760. Accordingly, for purposes of the present application, such polymer-dispersed electrophoretic media are regarded as sub-species of encapsulated electrophoretic media.

A related type of EPD is a so-called “microcell electrophoretic display,” also known as MICROCUP®. In a microcell EPD, the charged particles and the fluid are not encapsulated within microcapsules but instead are retained within a plurality of cavities formed within a carrier medium, typically a polymeric film. See, e.g., U.S. Pat. Nos. 6,672,921 and 6,788,449, both of which are incorporated herein by reference in their entireties.

Although electrophoretic media are often opaque (since, e.g., in many electrophoretic media, the particles substantially block transmission of visible light through the display) and operate in a reflective mode, many EPDs can be made to operate in a so-called “shutter mode” in which one display state is substantially opaque and one is light-transmissive. See, e.g., U.S. Pat. Nos. 5,872,552; 6,130,774; 6,144,361; 6,172,798; 6,271,823; 6,225,971; and 6,184,856. Dielectrophoretic displays, which are similar to EPDs but rely upon variations in electric field strength, can operate in a similar mode; see, e.g., U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated EPD typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See, e.g., U.S. Pat. No. 7,339,715); and other similar techniques.) Thus, the resulting display can be flexible. Further, because the display medium can be printed, using a variety of methods, the display itself can be made inexpensively.

The aforementioned U.S. Pat. No. 6,982,178 describes a method of assembling a solid electro-optic display (including an encapsulated EPD), which is well adapted for mass production. Essentially, this patent describes a so-called “front plane laminate” (FPL), which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, e.g., aluminum or ITO, or may be a conductive polymer. Poly (ethylene terephthalate) (PET) films coated with aluminum or ITO are available commercially, e.g., as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations. Typically, in a first lamination the double release sheet is laminated to a front electrode to form a front sub-assembly, and then in a second lamination the front sub-assembly is laminated to a backplane to form the final display, although the order of these two laminations could be reversed if desired.

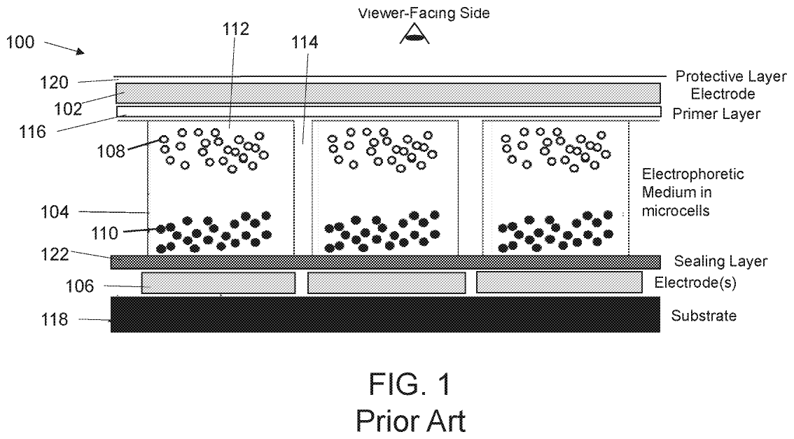

FIG. 1 illustrates a representative EPD 100, in which the electrophoretic medium is encapsulated in microcells. The EPD 100 includes a top (viewer facing) transparent electrode 102, an electrophoretic medium 104, and a bottom electrode layer 106 (forming part of the backplane) comprising pixel electrodes of an active matrix of pixels controlled, e.g., with thin film transistors (TFT). In the illustrative example of FIG. 1, the electrophoretic medium 104 includes oppositely charged white and black particles 108, 110, though EPDs are also known to include a single set of particles or multiple sets of particles of a variety of colors.

The electrophoretic medium 104 is compartmentalized by an array of microcells 112 formed in a microcell panel. The microcells 112 are separated by microcell partition walls 114 formed, e.g., by an embossing process. The microcells have openings sealed by a sealing layer 122. The openings can have a variety of shapes (when viewed from the top or bottom) including, e.g., hexagonal, triangular, and rectangular shapes.

A primer layer 116 can be disposed adjacent the electrode layer 102 to improve adhesion of the microcell panel to the electrode layer 102. The entire display stack is typically disposed on a substrate 118, which may be rigid or flexible. The displays typically also include a protective layer 120, which may simply protect the top electrode 102 from damage, or it may envelop the entire display to prevent ingress of water, etc. The structures of EPDs and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

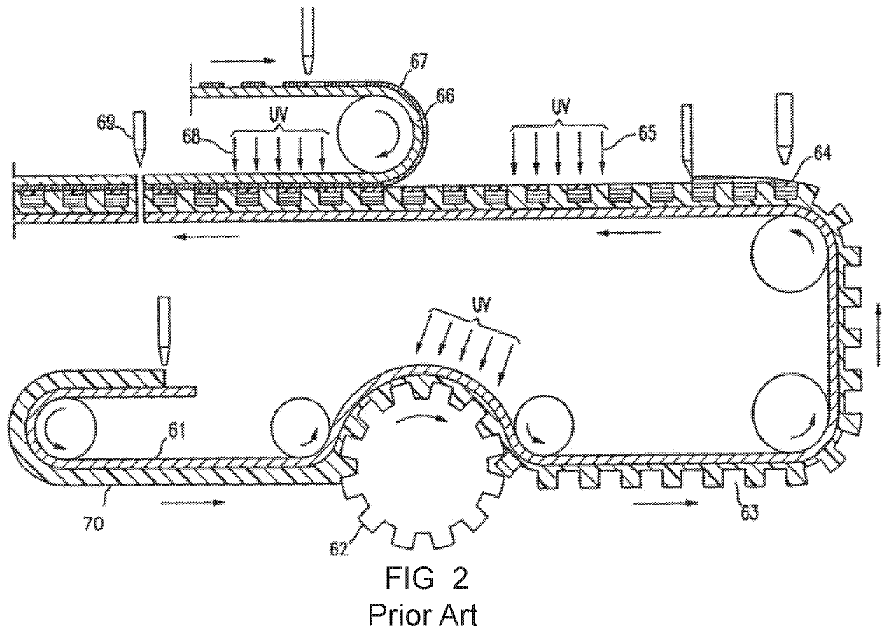

An FPL film for use in the EPD 100 can be produced by various processes including a roll-to-roll process as illustrated in FIG. 2. In the first step of the process, a layer 70 of an embossing composition, e.g., a thermoplastic, thermoset, or a precursor thereof, optionally with a solvent, is deposited on a light-transmissive substrate 61. The light-transmissive substrate 61 is coated with a conductive layer. (The solvent, if present, readily evaporates.) A primer layer (i.e., an electrode protection layer) may be used to increase the adhesion between the layer of embossing composition and the supporting layer, which may be the PET. Additionally, an adhesion promoter may be used in the primer layer to improve adhesion to the supporting layer. In the second step, the layer 70 is embossed at a temperature higher than the glass transition temperature of the layer material by a pre-patterned embossing tool 62. (The primer and/or adhesion promoter may be adjusted to decrease adhesion to the embossing tool 62.) In the third step, the patterned layer 70 is released from the embossing tool 62 preferably during or after it is hardened, e.g., by cooling. The characteristic pattern of microcells 63 separated by microcell partition walls is now established. In step four, the microcells 63 are filled with a bistable electrophoretic fluid 64. In some embodiments, the electrophoretic fluid will include a sealing composition that is incompatible with the electrophoretic fluid 64 and has a lower specific gravity than the solvent and the pigment particles in the electrophoretic fluid 64. In such embodiments, the sealing composition will rise to the top of the microcells 63, whereby it can be hardened in subsequent steps. As an alternative (not shown in FIG. 2), the sealing composition may be overcoated after the microcells 63 are filled with the electrophoretic fluid 64. In the next step, the microcells 63 filled with electrophoretic fluid 64 are sealed by hardening the sealing composition, e.g., with UV radiation 65 or by heat or moisture. In the sixth step, the sealed microcells are laminated to a second transparent conductive film 66, which may be pre-coated with an optically clear adhesive layer 67, which may be a pressure sensitive adhesive, a hot melt adhesive, a heat, moisture, or radiation curable adhesive. Preferred materials for the optically-clear adhesive include acrylics, styrene-butadiene copolymers, styrene-butadiene-styrene block copolymers, styrene-isoprene-styrene block copolymers, polyvinylbutyal, cellulose acetate butyrate, polyvinylpyrrolidone, polyurethanes, polyamides, ethylene-vinylacetate copolymers, epoxides, multifunctional acrylates, vinyls, vinylethers, and their oligomers, polymers, and copolymers. In the final step the finished sheets may be cut, e.g., with a knife edge 69, or with a laser cutter. In some embodiments, an eighth step, including laminating another optically-clear adhesive and a release sheet may be performed on the finished film so that it can be shipped in section sheets or rolls and cut to size when it is to be used, e.g., for incorporation into a display or other device/substrate.

Manufacturing restrictions can limit the size of FPL panels that can be produced. Large-area EPDs can be constructed from an array of smaller FPL panels connected together in a tiled arrangement. However, electrophoretic fluid leakage can occur at panel edges since the partition walls in each panel defining the microcells are generally poor barriers and may not reliably contain the electrophoretic fluid. The partition walls at seams between adjacent panels are particularly susceptible to damage from laser cutting during manufacture and through use over time. Consequently, the peripheral edges of each panel are typically edge sealed prior to being tiled together to prevent electrophoretic fluid leakage. Unfortunately, the edge sealing can result in thick and dark separation seams between adjacent FPL panels, compromising the appearance of displayed images. A need exists for FPL panels that can be tiled together to make large-area EPDs without significantly adversely impacting the aesthetic appearance of the display.

According to one aspect of the invention, a large-area EPD is constructed from an array of smaller FPL panels connected together in a tiled arrangement. The FPL panels include peripheral sidewalls to reduce the risk of leakage of the electrophoretic fluid at seams between adjacent panels and to reduce gaps between active areas of adjacent panels. As a result, large-area EPDs can be constructed from tiled FPL panels with reduced or minimal impact on the aesthetic appearance of the display.

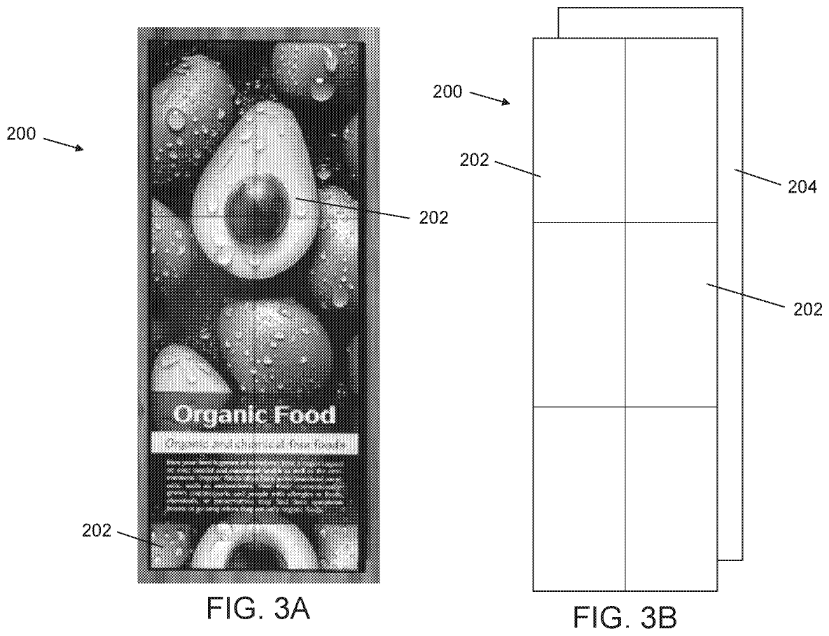

FIG. 3A is a photograph showing one example of a large-area EPD 200 constructed from a 2×3 array of FPL panels 202 connected to each other in a tiled arrangement in accordance with one or more embodiments. FIG. 3B is an exploded view of the EPD 200 showing the 2×3 array of FPL panels 202 laminated on a TFT backplane 204 to form the EPD 200.

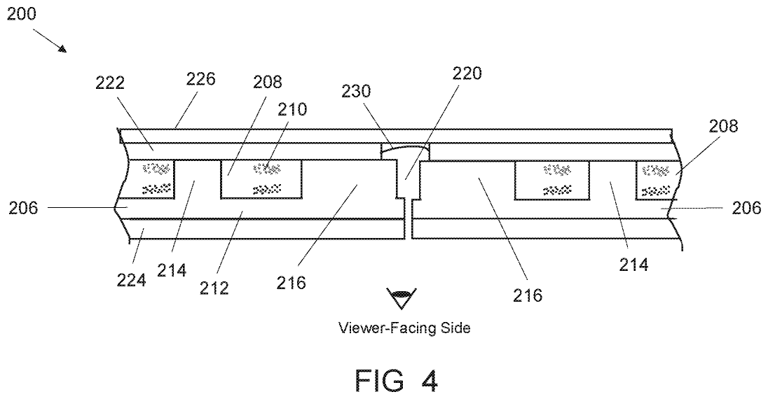

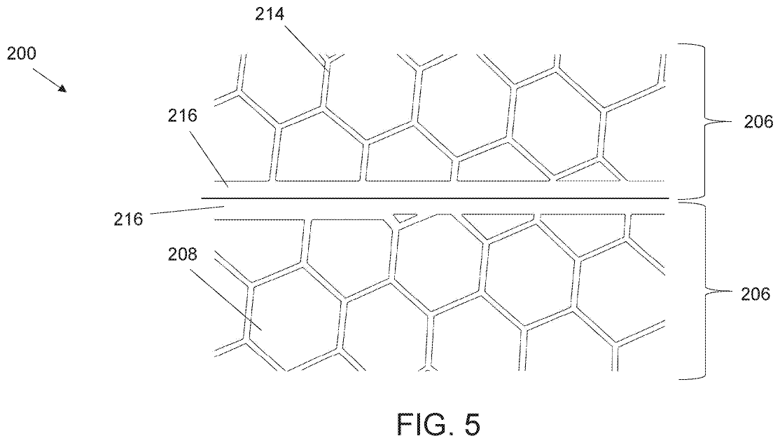

FIG. 4 is a cross-section view of a portion of the EPD 200 illustrating connection of two microcell panels 206 in the EPD. FIG. 5 is a top plan view showing two connected microcell panels 206. The microcell panels 206 are joined to each other in a side-by-side tiled arrangement. Each microcell panel 206 includes the array of microcells 208 for holding the electrophoretic medium 210. The microcells 208 are defined by a base layer 212 and an arrangement of partition walls 214 extending orthogonally from one side of the base layer 212. The microcell openings defined by the partition walls 214 can have a variety of shapes, including hexagonal shapes (as shown in FIG. 5) as well as round, square, or rectangular shapes. The microcell openings are sealed by a sealing layer 222.

The EPD 200 also includes a viewer-facing transparent electrode layer 224 and an opposite electrode layer 226 (forming part of the backplane) comprising pixel electrodes of an active matrix of pixels controlled, e.g., with thin film transistors (TFT).

The microcell panels 206 also include sidewalls 216 extending orthogonally from the peripheral edges of the base layer 212. Adjacent microcell panels 206 are joined to each other at their peripheral edges such that a sidewall 216 of each microcell panel 206 is aligned with and next to a sidewall 216 of an adjacent microcell panel 206 along the seam between the adjacent microcell panels 206.

The peripheral sidewalls 216 have a greater thickness than the partition walls 214 defining the microcells 208. The thicker sidewalls 216 provide an improved barrier reducing the risk of permeation of electrophoretic fluid through the sidewalls 216 and thereby reducing the risk of fluid leakage at the seams between adjacent FPL panels. While the sidewalls 216 are thicker than the partition walls 214, they are not so thick that they create a visually unattractive gap between the panels. In one or more embodiments, the thickness of the partition walls 214 ranges from about 2 um to 50 um, and the thickness of the sidewalls 216 ranges from about 4 um to 5000 um. In one exemplary embodiment, the thickness of each partition wall 214 is about 12 um, and the thickness of each sidewall 216 is about 50 um.

In one or more embodiments, the base layer 212, the sidewalls 216, and the partition walls 214 in each microcell panel 206 are integrally constructed. For example, the microcell panels 206 may be constructed by an embossing process similar to the roll-to-roll process depicted in FIG. 2. Alternatively, the sidewalls 216 can be separately formed on the base layer 212 of a microcell panel 206 using various printing processes such as, e.g., inkjet printing, screen printing, or gravure printing.

Tiled displays with sidewalls 216 at the periphery of the FPL panels in accordance with various embodiments of the invention have significant advantages over prior art tiled displays. As noted above, the presence of the sidewalls 216, which are thicker than the partition walls 214, provides a more robust barrier for inhibiting permeation of electrophoretic fluid and thereby reduces the risk of fluid leakage at the seams between adjacent FPL panels. Fluid leakage can cause edge damage growth over time, adversely impacting the aesthetic appearance of the display.

As part of the display manufacturing process, the edges of microcell panels 206 are cut using a laser cutting process (e.g., by a UV 355nm Femtosecond laser). The straight shape of the sidewalls 216 along the peripheral edges of the microcell panels 206 provides beneficial alignment for laser cutting. This enables precise laser cutting and reduces the risk of damaging the microcell partition walls 214 and other parts of the panel 206. In addition, the panels 206 can be closely cut at the sidewalls 216 (e.g., 20-30 um from the sidewalls 216), thereby minimizing the size of the tiling gap 220 at the seam between adjacent panels 206. By way of example, the tiling gap 220 between adjacent panels 206 can be about 17 um. In one or more embodiments, the tiling gap 220 is tapered such that the end of the gap at the viewer-facing side is narrower than the opposite end at the non-viewing side as depicted in FIG. 4.

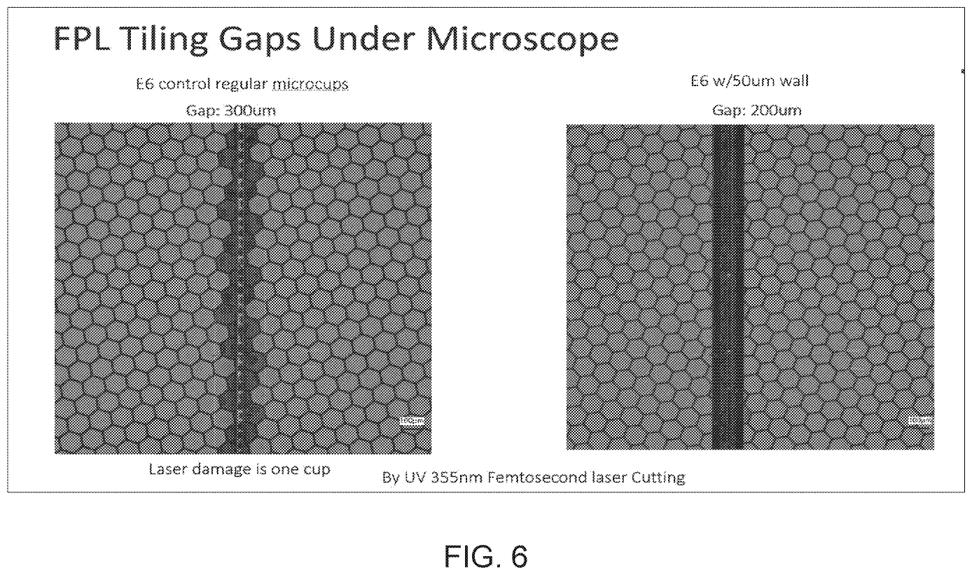

FIG. 6 illustrates how inclusion of sidewalls 216 in microcell panels 206 reduces the edge damage gap between adjacent microcell panels 206. The left side image in FIG. 6 shows an example of the connection of two prior art microcell panels without sidewalls 216. As shown, the process of cutting the edges of the panels damages a line of microcells 208 along the length of the seam between adjacent panels. The damaged microcells cannot hold electrophoretic fluid and are inactive and appear as a dark line between adjacent panels. The damaged area can have a thickness of about 300 um.

The right side image in FIG. 6 shows the connection of two microcell panels 206 having sidewalls 216 as described above. The gap between adjacent panels has a gap width of about 200 um, which is less than the gap width in prior art tiled displays described above.

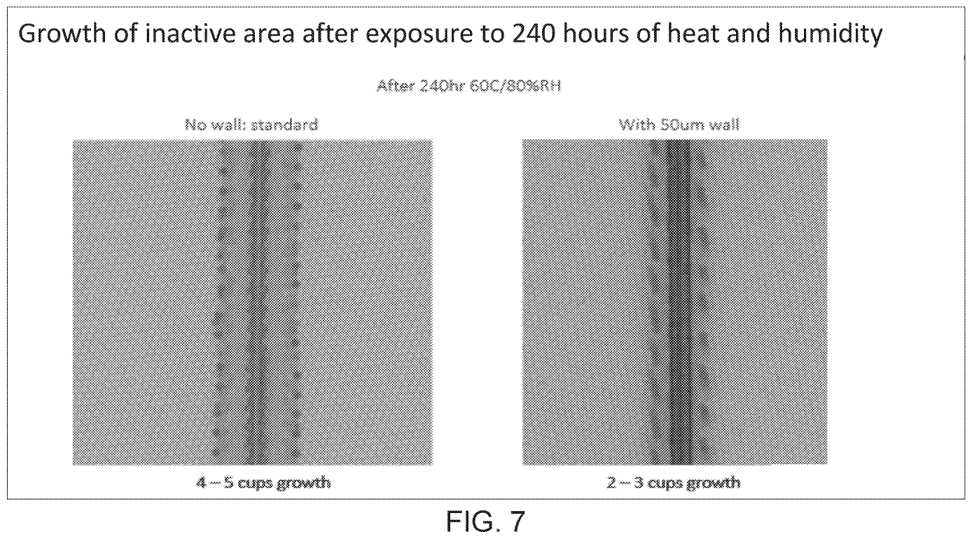

FIG. 7 shows the results of reliability testing for edge damage growth over time for a prior art tiled display (left side image) and microcell panels with sidewalls 216 in accordance with various embodiments (right side image). The edge growth was measured after 240 hours at 60 °C, 80% RH. As shown, the prior art tiled display experienced gap growth of about 4-5 microcells, whereas the display having sidewalls 216 experienced a smaller gap growth of about 2-3 microcells.

In one or more embodiments, the tiling gap 220 between adjacent microcell panels 206 is optionally sealed with a filler material 230 in order to increase the robustness of the connection between the panels 206. The filler material 230 preferably comprises an epoxy such as edge seal 7301. The filler material preferably has good flow properties at the time of the filling. The filler 230 is then cured and preferably has high modulus (stiffness) and a high glass transition temperature (Tg) (heat resistance) to maintain strength and rigidity at elevated temperatures.

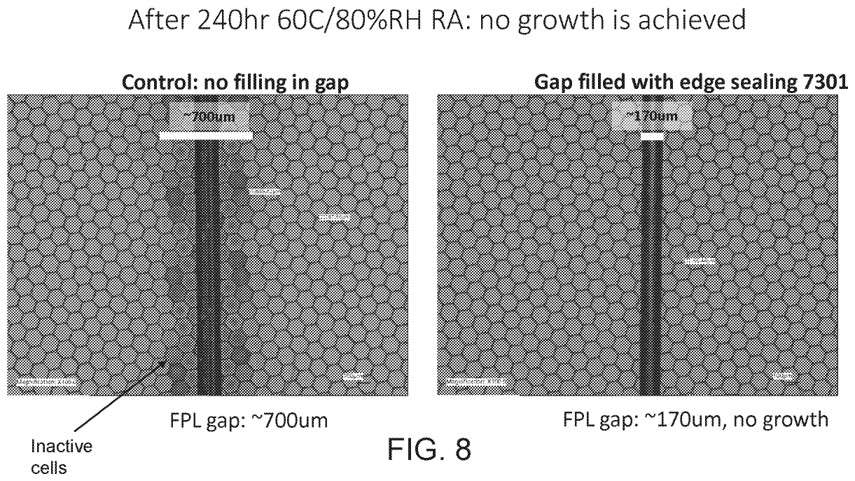

FIG. 8 shows the results of reliability testing for edge damage growth over time of a tiled display without filler material in the edge gap (left side image) and a tiled display with filler material 230 in the edge gap (right side image). The edge growth was measured after 240 hours at 60 °C, 80% RH. As shown, the tiled display without filler material experienced greater edge damage gap growth than the tiled display with filler material.

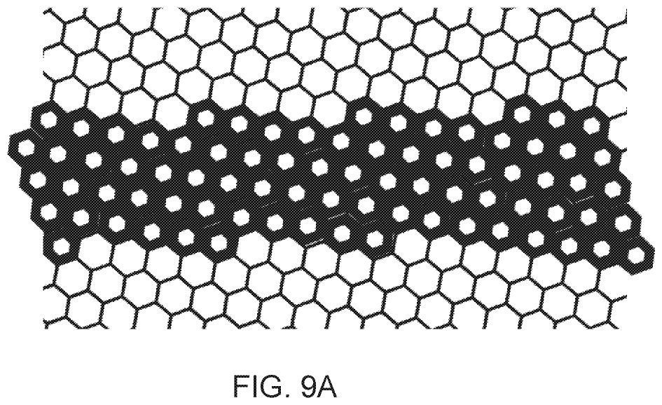

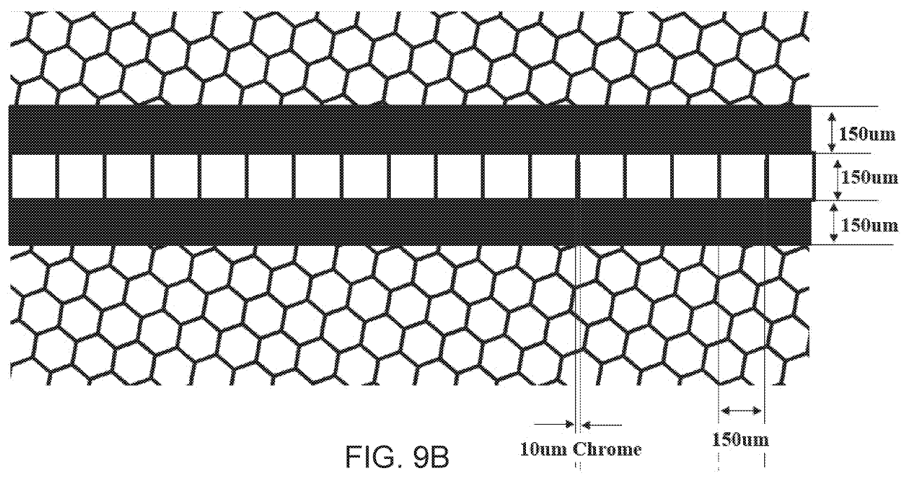

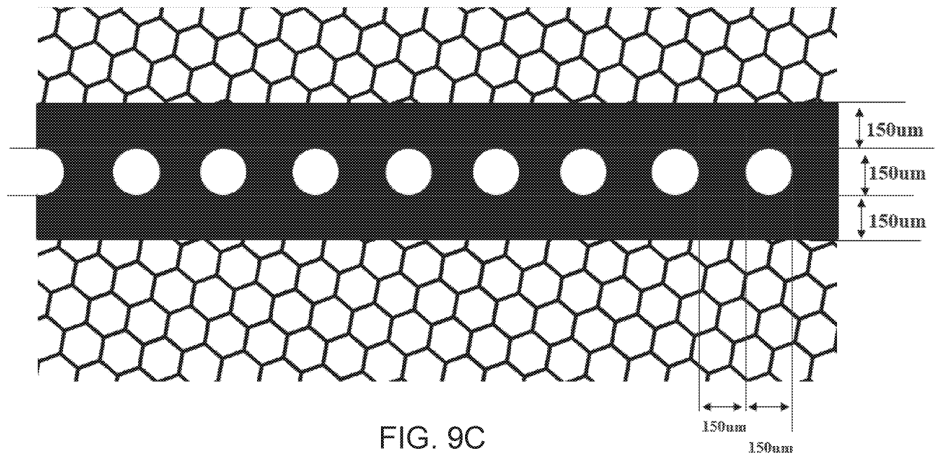

FIGS. 9A-9C show patterned sidewalls in accordance with one or more alternative embodiments. FIG. 9A shows a sidewall formed from hexagonal cups having, e.g., a 40 um or 50 um wall thickness and a 130 um pitch. FIG. 9B shows a sidewall formed from a structure having square cups with a width of about 150 um. FIG. 9C shows a sidewall formed from a structure having round cups with a diameter of about 150 um.

It will be apparent to those skilled in the art that numerous changes and modifications can be made to the specific embodiments of the invention described above without departing from the scope of the invention. Accordingly, the whole of the foregoing description is to be interpreted in an illustrative and not in a limitative sense.

1. A microcell panel assembly in an electrophoretic display comprising a plurality of microcell panels, each microcell panel comprising:
(a) a base layer having a plurality of peripheral edges;
(b) at least one sidewall extending orthogonally from one side of the base layer along one or more of the peripheral edges of the base layer; and
(c) a plurality of partition walls extending orthogonally from said one side of the base layer to define with the at least one sidewall and the base layer an array of microcells sealable by a sealing layer for holding electrophoretic fluid therein;
wherein the microcell panels are joined to each other in a side-by-side tiled arrangement such that at least one sidewall of each microcell panel is aligned with and adjacent to a sidewall of an adjacent microcell panel at a seam between the adjacent microcell panels, and wherein the thickness of each sidewall is greater than the thickness of the partition walls to reduce risk of leakage of the electrophoretic fluid at each seam.

2. The microcell panel assembly of claim 1, wherein the thickness of each of the partition walls is about 2 um to 50 um.

3. The microcell panel assembly of claim 1, wherein the thickness of each of the partition walls is about 12 um.

4. The microcell panel assembly of claim 1, wherein the thickness of each sidewall is about 4 um to 5000 um.

5. The microcell panel assembly of claim 1, wherein the thickness of each sidewall is about 50 um.

6. The microcell panel assembly of claim 1, wherein each microcell has a round, square, rectangular, or hexagonal shape.

7. The microcell panel assembly of claim 1, wherein tiling gaps at the seams between the adjacent microcell panels are not edge sealed.

8. The microcell panel assembly of claim 1, wherein tiling gaps at each seam between the adjacent microcell panels are sealed with a filler material.

9. The microcell panel assembly of claim 1, wherein each sidewall is patterned.

10. The microcell panel assembly of claim 1, wherein tiling gaps at each seam between the adjacent microcell panels are tapered such that an end of each tiling gap at a viewer-facing side of the electrophoretic display is narrower than an opposite end.

11. The microcell panel assembly of claim 1, wherein the base layer, the at least one sidewall, and the plurality of partition walls in each microcell panel are integrally constructed.

12. An electrophoretic display, comprising:
a plurality of microcell panels joined to each other in a side-by-side tiled arrangement, each microcell panel comprising: (a) a base layer having a plurality of peripheral edges, (b) at least one sidewall extending orthogonally from one side of the base layer along one or more of the peripheral edges of the base layer, and (c) a plurality of partition walls extending orthogonally from said one side of the base layer to define with the at least one sidewall and the base layer an array of microcells for holding electrophoretic fluid, wherein the microcell panels are joined to each other such that a sidewall of each microcell panel is aligned with and adjacent to a sidewall of an adjacent microcell panel at a seam between the adjacent microcell panels, and wherein the thickness of each sidewall is greater than the thickness of the partition walls to reduce risk of leakage of the electrophoretic fluid at each seam;
a light transmissive electrode layer superposed on a viewing side of each of the plurality of microcell panels; and
a backplane comprising at least one electrode superposed on a side of the plurality of microcell panels opposite the viewing side.

13. A method of manufacturing an electrophoretic display, comprising the steps of:
(a) forming a plurality of microcell panels each on a light transmissive electrode layer, each microcell panel comprising a base layer having a plurality of peripheral edges; at least one sidewall extending orthogonally from one side of the base layer along one or more of the peripheral edges of the base layer; and a plurality of partition walls extending orthogonally from said one side of the base layer to define with the at least one sidewall and the base layer an array of microcells for holding electrophoretic fluid, wherein the thickness of each sidewall is greater than the thickness of the partition walls;
(b) filling the microcells of each microcell panel with the electrophoretic fluid and sealing the electrophoretic fluid in the microcells with a sealing layer;
(c) joining the microcell panels to each other in a side-by-side tiled arrangement such that a sidewall of each microcell panel is aligned with and adjacent to a sidewall of an adjacent microcell panel at a seam between the adjacent microcell panels; and
(d) securing a backplane comprising at least one electrode on a side of the microcell panels joined in step (c) opposite the light transmissive electrode layers.

14. The method of claim 13, wherein tiling gaps at the seams between the adjacent microcell panels are not edge sealed.

15. The method of claim 13, further comprising sealing tiling gaps at each seam between the adjacent microcell panels with a filler material.

16. The method of claim 15, wherein the filler material comprises an epoxy.

17. The method of any of claims 13, wherein tiling gaps at each seam between the adjacent microcell panels are tapered such that an end of each tiling gap at a viewer-facing side of the electrophoretic display is narrower than an opposite end.

18. The method of any of claims 13, wherein the base layer, the at least one sidewall, and the plurality of partition walls in each microcell panel are integrally constructed.

19. The method of any of claims 13, wherein the microcell panels are formed by an embossing process.

20. The method of any of claims 13, wherein the at least one sidewall in each microcell panel is formed on the base layer using inkjet printing, screen printing, or gravure printing.
